(19) United States
(12) Patent Application Publication
(10) Pub. No.: US 2026/0174016 A1
(43) Pub. Date: Jun. 25, 2026

(54) PLANT CULTIVATION METHOD

(71) Applicants: Eriko SATO, Tokyo (JP); TSUBU CO., LTD., Tokyo (JP)

(72) Inventor: Eriko SATO, Tokyo (JP)

(21) Appl. No.: 18/995,363

(22) PCT Filed: Jul. 20, 2022
(86) PCT No.: PCT/JP2022/028260

§ 371 Date: Jan. 16, 2025

(51) Int. Cl. A01G 7/04; A01G 22/05

(52) U.S. Cl. CPC A01G 7/045; A01G 22/05

(57) ABSTRACT

In a plant cultivation method according to the present invention, in the second step which corresponds to a period from cotyledon opening to inflorescence development, PPFD-VL is set to be 29 (μmol/m²·s) or more and 120 (μmol/m²·s) or less, PPFD-B is set to be 5 (μmol/m²·s) or more and 20 (μmol/m²·s) or less, PPFD-G is set to be 10 (μmol/m²·s) or more and 50 (μmol/m²·s) or less, PPFD-R is set to be 14 (μmol/m²·s) or more and 50 (μmol/m²·s) or less, and a color temperature of irradiation light is set to be 3000 K or higher and 4800 K or lower.

### TECHNICAL FIELD

The present invention relates to a plant cultivation method for cultivating plants well throughout the year.

### BACKGROUND ART

Plants have flowers, fruits, or roots, stems, and leaves during the growth process. Photosynthesis is one of various factors affecting plant growth. Photosynthesis requires light and usually sun light is used for photosynthesis. However, light quality and duration of sunlight exposed to the plants vary throughout the year due to seasonal fluctuations and other factors. Thus, in the natural environment, it is difficult to grow plants of the same quality throughout the year.

A cultivation technique, in which artificial light sources are prepared as a substitute for sun light and the light is used to grow plant, is known (for example, Patent Literature 1). Patent Literature 1 especially focuses on photosynthetic photon flux density (PPFD) to grow plants.

### CITATION LIST

### Patent Literature

Patent Literature 1: Japanese Unexamined Patent Application Publication No. 2004-81110

### SUMMARY OF INVENTION

### Technical Problem

However, Patent Literature 1 focuses only on PPFD of red and green lights, but not on PPFD of blue light. In addition, for plant growth, it is necessary to optimize the total PPFD levels of blue, green, and red lights, and the PPFD levels of each of the blue, green, and red light contained therein.

A problem here is that in the case of cultivating plants under a combination of monochromatic light of red, blue, and green, the plants grow poorly due to different total color balance of light. Color temperature that represents a quantitative numeric value of color of light emitted from a light source can also be considered as an important parameter for plant growth. However, it is not known that the combination of color temperature and PPFD encourages good plant growth.

The present invention has been made in consideration of the above-described related art, and an objective of the present invention is to provide a plant cultivation method that allows plants grow well throughout the year by considering proper PPFD level and color temperature.

### Solution to Problem

In order to achieve the above objective, the present invention provides a plant cultivation method characterized in that the plant is irradiated with irradiation light containing visible light having a photosynthetic photon flux density (PPFD-VL) of 29 (μmol/m²·s) or more and 120 (μmol/m²·s) or less in the visible light region with a wavelength of 400 nm or more and 700 nm or less in a second step which corresponds to a period from cotyledon opening to inflorescence development, wherein out of the visible light, the photosynthetic photon flux density in a blue light region (PPFD-B) with a wavelength of 400 nm or more and less than 500 nm is set to be 5 (μmol/m²·s) or more and 20 (μmol/m²·s) or less, the photosynthetic photon flux density in a green light region (PPFD-G) with a wavelength of 500 nm or more and less than 600 nm is set to be 10 (μmol/m²·s) or more and 50 (μmol/m²·s) or less, the photosynthetic photon flux density in a red light region (PPFD-R) with a wavelength of 600 nm or more and less than 700 nm is set to be 14 (μmol/m²·s) or more and 50 (μmol/m²·s) or less, and a color temperature of the irradiation light is set to be 3000 K or higher and 4800 K or lower.

Preferably, the plant is irradiated with the irradiation light containing the visible light having the photosynthetic photon flux density (PPFD-VL) of 59 (μmol/m²·s) or more and 135 (μmol/m²·s) or less in the visible light region with the wavelength of 400 nm or more and 700 nm or less in a first step which corresponds to a period from sowing to germination of seeds, prior to the second step, and out of the visible light, the photosynthetic photon flux density in the blue light region (PPFD-B) with the wavelength of 400 nm or more and less than 500 nm is set to be 11 (μmol/m²·s) or more and 25 (μmol/m²·s) or less, the photosynthetic photon flux density in the green light region (PPFD-G) with the wavelength of 500 nm or more and less than 600 nm is set to be 20 (μmol/m²·s) or more and 50 (μmol/m²·s) or less, the photosynthetic photon flux density in the red light region (PPFD-R) with the wavelength of 600 nm or more and less than 700 nm is set to be 28 (μmol/m²·s) or more and 60 (μmol/m²·s) or less.

Preferably, the plant belongs to the family Rosaceae, and in the second step, the plant is irradiated with the irradiation light containing the visible light having the photosynthetic photon flux density (PPFD-VL) of 90 (μmol/m²·s) or more and 120 (μmol/m²·s) or less in the visible light region with the wavelength of 400 nm or more and 700 nm or less, and out of the visible light, the photosynthetic photon flux density in the blue light region (PPFD-B) with the wavelength of 400 nm or more and less than 500 nm is set to be 10 (μmol/m²·s) or more and 20 (μmol/m²·s) or less, the photosynthetic photon flux density in the green light region (PPFD-G) with the wavelength of 500 nm or more and less than 600 nm is set to be 30 (μmol/m²·s) or more and 50 (μmol/m²·s) or less, the photosynthetic photon flux density in the red light region (PPFD-R) with the wavelength of 600 nm or more and less than 700 nm is set to be 30 (μmol/m²·s) or more and 50 (μmol/m²·s) or less, and the color temperature of the irradiation light in the second step is set to be 4000 K or higher and 4500 K or lower.

Preferably, the plant is strawberry.

Preferably, the plant is irradiated with the irradiation light in a temperature environment of 9° C. or higher and 28° C. or lower in the first and second steps.

Preferably, a first peak value which is a peak value at a maximum wavelength of the irradiation light is 400 nm or more and 500 nm or less and a second peak value which is a peak value at the second highest wavelength of the irradiation light is 550 nm or more and 700 nm or less in the first and second steps.

### Advantageous Effects of Invention

According to the present invention, the plant can be grown well throughout the year by considering proper PPFD level and color temperature. If the plant belongs to the family Rosaceae, the plant can be grown well throughout the year by considering more optimal PPFD level and color temperature.

### BRIEF DESCRIPTION OF DRAWINGS

FIG. 1 is a schematic diagram of a cultivation system employing a plant cultivation method according to the present invention.

### DESCRIPTION OF EMBODIMENTS

Growth processes of seed propagation type of plants include germination of seeds sown, subsequent opening of a cotyledon, and growth into parent plants. In the present invention, a first step for this type of plants involves the processes from sowing to germination. For the seed propagation type of plants, the second step corresponds to the processes of development of the cotyledon into the parent plant. For other plants that reproduce via runners, underground stems, cuttings, and spores or plants that reproduce via germination of bulbs, the second step includes the processes after opening of a cotyledon of new plant. For plants that produce flowers and fruits, the second step also involves the processes of inflorescence development and fruiting. In addition, some seeds are favored by light and the other seeds are inhibited by light. The condition of the first step is applied to light-favored seed plants and plants that reproduce by runners, cuttings, bulbs, and spores. The condition of the second step can be applied to most plants.

PPFD is a concept used to measure light irradiated on plants to grow plants. This PPFD is referred to as photosynthetic photon flux density (the number of photons that pass through per unit area per unit time). The PPFD is classified into the following types according to light wavelength regions.
PPFD-UV (UV: UltraViolet): wavelength region of 380 nm or more and less than 400 nm (ultraviolet light region)
PPFD-VL (VL: Visible Light): wavelength region of 400 nm or more and less than 700 nm (visible light region)
PPFD-FR (FR: Far-red Light): wavelength region of 700 nm or more and less than 800 nm (far-red light region)
PPFD-IR (IR: Infrared Light): wavelength region of 701 nm or more and less than 780 nm (infrared light region)

Among the above-mentioned light regions, PPFD-VL is further divided into the following regions.
PPFD-B: wavelength region of 400 nm or more and less than 500 nm (blue light region)
PPFD-G: wavelength region of 500 nm or more and less than 600 nm (green light region)
PPFD-R: wavelength region of 600 nm or more and less than 700 nm (red light region)

In the present invention, irradiation light containing the following visible light is used as the light irradiated on plants (irradiation light) in the first step.
PPFD-VL: 59 (μmol/m²·s) or more and 135 (μmol/m²·s) or less
PPFD-B: 11 (μmol/m²·s) or more and 25 (μmol/m²·s) or less
PPFD-G: 20 (μmol/m²·s) or more and 50 (μmol/m²·s) or less
PPFD-R: 28 (μmol/m²·s) or more and 60 (μmol/m²·s) or less

In the present invention, irradiation light containing the following visible light is used as the light irradiated on plants in the second step.
PPFD-VL: 29 (μmol/m²·s) or more and 120 (μmol/m²·s) or less
PPFD-B: 5 (μmol/m²·s) or more and 20 (μmol/m²·s) or less
PPFD-G: 10 (μmol/m²·s) or more and 50 (μmol/m²·s) or less
PPFD-R: 14 (μmol/m²·s) or more and 50 (μmol/m²·s) or less

The irradiation light having the following color temperature was used at least in the second step. This color temperature can be achieved, for example, by coloring LED light chips or LED light itself, which emit the irradiation light.
Correlated Color Temperature (CCT): 3000 K or higher and 4800 K or lower

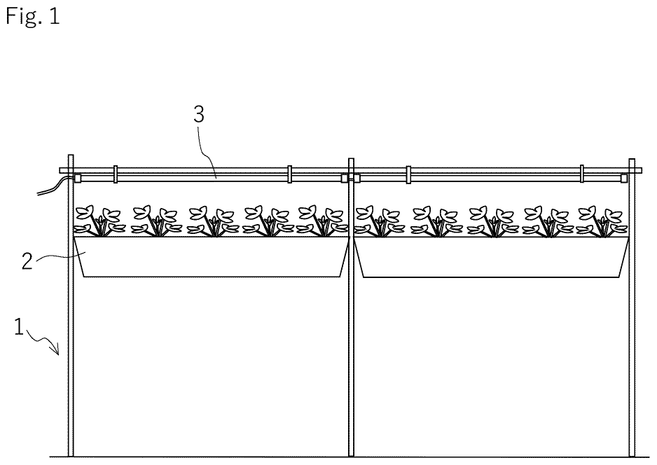

Plants were cultivated under the above-described conditions. A seed propagation type of strawberry was used as a plant subject. As shown in FIG. 1, a cultivation system was constructed by forming a frame body 1 using iron pipes, etc. and a planter 2 made of plastic, for example, was disposed in the frame body 1. The irradiation light from a light source 3 disposed at the upper part of the planter 2, was irradiated on the plant. All of the frame body 1, planter 2, and light source 3 were disposed in a plastic greenhouse under shading conditions. The PPFD and color temperature were measured using HPCS-300P (manufactured by Hangzhou Hopoo Light&Color Technology Co., Ltd.). A plant cultivation method according to the present invention can be applied to ordinary indoor cultivation, but not limited to greenhouse cultivation.

Results obtained from the first step conducted under various conditions are shown in Table 1. The number of the seeds sown was the same in all Examples.

TABLE 1

| | | | | | | | | | First | Second | Number of |
|---|---|---|---|---|---|---|---|---|---|---|---|
| | | | | | | | | | peak | peak | seeds |
| | PPFD-VL | PPFD-UV | PPFD-B | PPFD-G | PPFD-R | PPFD-FR | PPFD-IR | CCT | value | value | germinated |
| example 1 | 121.2 | 0.2 | 22.7 | 43.2 | 55.3 | 11.1 | 0.8 | 4234 | 449 | 640 | 50 |
| example 2 | 70.2 | 0.1 | 12.6 | 24.8 | 32.8 | 6.6 | 0.5 | 4087 | 450 | 640 | 46 |
| Comparative | 54.8 | 0.1 | 10.2 | 19.7 | 24.8 | 4.6 | 0.3 | 4248 | 449 | 640 | 28 |
| example 1 | | | | | | | | | | | |
| Comparative | 49.3 | 0.1 | 9.1 | 17.7 | 22.6 | 4.2 | 0.3 | 4187 | 449 | 640 | 19 |
| example 2 | | | | | | | | | | | |

As is obvious from Table 1, the number of seeds that germinated was good in Examples 1 and 2 in which the plant was cultivated within the range of the above-mentioned conditions. The number of seeds that germinated in Comparative examples 1 and 2 was not good because values of the PPFD-VL, PPFD-B, PPFD-G, and PPFD-R were out of the range of the above-mentioned conditions.

Results obtained from the second step conducted under various conditions are shown in Table 2. In all of the examples in the second step, the seeds germinated in Example 1 were used.

TABLE 2

| | | | | | | | | | First | Second | |
|---|---|---|---|---|---|---|---|---|---|---|---|
| | | | | | | | | | peak | peak | Number of |
| | PPFD-VL | PPFD-UV | PPFD-B | PPFD-G | PPFD-R | PPFD-FR | PPFD-IR | CCT | value | value | inflorescences |
| example 3 | 106.1 | 0.2 | 18.7 | 39.1 | 48.3 | 11.3 | 1.2 | 4181 | 447 | 640 | 17 |
| example 4 | 100.3 | 0.3 | 19.5 | 45.3 | 35.5 | 6.7 | 1.4 | 4179 | 453 | 591 | 16 |
| example 5 | 31.2 | 0.1 | 5.6 | 11.6 | 14.1 | 4.4 | 0.7 | 4260 | 448 | 640 | 8 |
| example 6 | 42.4 | 0.1 | 5.6 | 18.0 | 18.9 | 1.7 | 0.2 | 3064 | 607 | 454 | 7 |
| Comparative | 25.1 | 0.1 | 4.5 | 9.3 | 11.3 | 4.0 | 0.7 | 4276 | 448 | 640 | 2 |
| example 3 | | | | | | | | | | | |
| Comparative | 16.0 | 0.1 | 2.9 | 5.9 | 7.2 | 2.8 | 0.5 | 4280 | 448 | 640 | 0 |
| example 4 | | | | | | | | | | | |
| Comparative | 153.4 | 0.3 | 34.4 | 69.0 | 50.0 | 6.8 | 1.0 | 4831 | 453 | 585 | 2 |
| example 5 | | | | | | | | | | | |
| Comparative | 79.5 | 0.2 | 17.7 | 35.5 | 26.4 | 4.8 | 0.9 | 4811 | 453 | 585 | 0 |
| example 6 | | | | | | | | | | | |
| Comparative | 18.5 | 0.1 | 4.0 | 7.8 | 6.8 | 3.0 | 0.8 | 4787 | 453 | 587 | 0 |
| example 7 | | | | | | | | | | | |
| Comparative | 16.7 | 0.1 | 3.6 | 6.9 | 6.2 | 3.1 | 0.8 | 4757 | 453 | 585 | 0 |
| example 8 | | | | | | | | | | | |
| Comparative | 13.7 | 0.1 | 2.9 | 5.6 | 5.2 | 2.8 | 0.7 | 4708 | 455 | 585 | 0 |
| example 9 | | | | | | | | | | | |
| Comparative | 37.7 | 0.1 | 5.0 | 31.6 | 1.1 | 0.8 | 0.3 | 8312 | 517 | None | 0 |
| example 10 | | | | | | | | | | | |

As is obvious from Table 2, the number of inflorescences was good in Examples 3 to 6 in which the plant was cultivated within the range of the above-mentioned conditions. The number of inflorescences in Comparative examples 3 to 5 and 7 to 9 was not good because values of the PPFD-VL, PPFD-B, PPFD-G, and PPFD-R were out of the range of the above-mentioned condition although the color temperature was within the range of the above-mentioned condition. The number of inflorescences was not good in Comparative Example 6 because the color temperature was out of the above-mentioned condition although values of the PPFD-VL, PPFD-B, PPFD-G, and PPFD-R were within the above-mentioned conditions. In Comparative example 10, the number of inflorescences was also not good because value of the PPFD-R and the color temperature were out of the above-mentioned conditions although values of the PPFD-VL, PPFD-B, and PPFD-G were within the above-mentioned conditions.

The plant used in experiments shown in Table 2 was strawberry belonging to the Rosaceae family as mentioned above. Judging from the results of Examples 3 and 4 that exhibited the better number of inflorescences, among Examples 3 to 6, the following condition in the second step is more preferable for plants in the Rosaceae family. In particular, this condition can be applied to strawberry actually investigated in this experiment as an optimum condition.
PPFD-VL: 90 (μmol/m²·s) or more and 120 (μmol/m²·s) or less
PPFD-B: 10 (μmol/m²·s) or more and 20 (μmol/m²·s) or less
PPFD-G: 30 (μmol/m²·s) or more and 50 (μmol/m²·s) or less
PPFD-R: 30 (μmol/m²·s) or more and 50 (μmol/m²·s) or less
Correlated Color temperature (CCT): 4000 K or higher and 4500 K or lower

Peak values of the irradiation light were also examined in Examples and Comparative examples listed in Tables 1 and 2. The peak value at a maximum wavelength of irradiation light was defined as a first peak value and the peak value at the second highest wavelength of irradiation light was defined as a second peak value. Conditions of the peak values 1 and 2 of the irradiation light were described below.
First peak value: 400 nm or more and 500 nm or less
Second peak value: 550 nm or more and 700 nm or less

In Examples 1 to 5, good results were obtained because the peak values were within the range of the above-mentioned peak conditions. Example 6 showed less favorable result than other Examples because both the first and second peak values were out of the range of the above-mentioned peak conditions. These results demonstrate that better result can be obtained if peak values are within the above-mentioned peak conditions. In Comparative examples 1 to 9, the obtained peak values were within the range of the above-mentioned peak conditions. However, PPFD values were out of the range, and thus the results were not good. Comparative example 10 in which the peak values were out of the above-mentioned peak conditions, also showed unfavorable results. Thus, more favorable results can be obtained if the first and second peak values are within the range of the above-mentioned peak conditions.

Moreover, temperature conditions for plant growth were also examined. Plants have optimum temperature range for their growth, and thus their growing season and growing area are limited in the natural environment. As a remedy, there may be a case that plant cultivation methods in which the cultivation environment is artificially controlled, is used in plant factory and so on. However, in such a method, maintaining a narrow temperature range, for example between 20° C. and 25° C., requires enormous amount of energy, and furthermore the introduction of expensive equipment will be necessary in order to precisely control the temperature. In recent years, reduction of CO₂ emissions has become an important issue to prevent global warming. There is increasing demand for technologies to reduce energy consumption in plant cultivation accordingly. If a large amount of fuel is used for temperature control, there is a possibility that changes in fuel prices may significantly affect changes in harvest prices. However, it is difficult to constantly maintain a certain temperature with less energy, and thus plants are grown in a temperature environment according to the outside temperature. For example, it is considered difficult to produce plants throughout the year under environment in which a maximum temperature is 30° C. or higher or a minimum temperature is 10° C. or less, since it causes poor growth of plant and poor development of inflorescence from which fruits and flowers are harvested.

Table 3 shows actual plant cultivation results of examination of temperature environment that does not greatly affect plant growth.

TABLE 3

| | Cultivation | Presence or | Presence or |
|---|---|---|---|
| | temperature | absence of | absence of |
| | (° C.) | inflorescences | fruiting |
| example 7 | 10.6-16.2 | Present | Present |
| example 8 | 20.7-23.6 | Present | Present |
| example 9 | 24.5-28.0 | Present | Present |
| Comparative | 5.3-7.4 | Absent | Absent |
| example 11 | | | |
| Comparative | 29.1-34.4 | Absent | Absent |
| example 12 | | | |

In all of Examples 7 to 9, the first step and the second step were conducted under the conditions of Example 1 and the temperature environments were changed. Fruiting of strawberry was observed in all Examples. It is preferable that plants are irradiated in temperature environment of 9° C. or higher and 28° C. or lower during the first step and the second step. In both Comparative examples 11 and 12, the plants were cultivated at temperature that was out of the rage of the above-mentioned temperature conditions, and as a result, inflorescences did not develop and fruits were not formed. Although all leaves were from yellow-green to green in Examples 7 to 9, one or more leaves were turned red in Comparative example 11. It is considered that strawberry went into so-called hibernation. All leaves were from yellow-green to green in Comparative example 12. Note that cultivation period of each Example in Table 3 was two months.

Based on the above results, in the present invention, with respect to the wavelength region of 400 nm to 700 nm which is required for photosynthesis, the irradiation light containing PPFD-B of 400 nm to 500 nm, PPFD-G of 500 nm to 600 nm, and PPFD-R of 600 nm to 700 nm at a specific ratio is set to be within the specific range of PPFD and color temperature. By controlling the light irradiated on the plants, optimal conditions for plant growth and inflorescence development can be provided. In addition, good conditions for the plant growth can be maintained with a small amount of energy and higher plant yield is expected even under the condition with severe temperature fluctuations. According to the present invention, strawberries can be continuously harvested and cultivated throughout the year using the identical plants which conventionally had to be abandoned since they were not able to make fruits after six months for planting.

The plant cultivation method according to the present invention was experimentally applied to various plants. Future Perfume, a rose variety, was used in Example 10 and Comparative example 13. Odeur d'Amour, a rose variety, was used in Example 11 and Comparative example 14. Fukuchi White, a variety of garlic, was used in Example 12. In this Example, one clove of peeled garlic was planted at 15 cm intervals. In these Examples, the irradiation light was applied to the plants not from directly above (at 90-degree angle) but from diagonally above (at 45-degree angle). Other conditions were the same as Example 1. Table contains the number of days from planting.

TABLE 4

| | Cultivation | | | | | |
|---|---|---|---|---|---|---|
| | temperature (° C.) | 10 days | 21 days | 47 days | 59 days | 82 days |
| example 10 | 10.6-16.2 | Unbloomed | Budding | Bud | One flower | — |
| | | | | | bloomed | |
| example 11 | 20.7-23.6 | Unbloomed | Budding | Bud | Two flower | — |
| | | | | | bloomed | |
| example 12 | 24.5-28.0 | 5 mm | 32 cm | 47 cm | 59 cm | 59 cm |
| Comparative | 5.3-7.4 | Unbloomed | Unbloomed | Unbloomed | Unbloomed | Unbloomed |
| example 13 | | | | | | |
| Comparative | 29.1-34.4 | Unbloomed | Unbloomed | Unbloomed | Unbloomed | Unbloomed |
| example 14 | | | | | | |

As is obvious from Table 4, both the roses and garlic grew well if the various PPFD and color temperature values fall under the range as shown in Example 1 and temperature environment is within the above-mentioned temperature environment condition (Examples 10 to 12). As shown in Comparative Examples 13 and 14, the plants did not grow well when temperature condition was out of the above-mentioned conditions. The number of open flowers was not counted after flowering (59 days or later) in Examples 10 and 11. According to the present invention, not only strawberry but also flowers including roses can bloom in the off-season using less energy. The same applies to garlic. The present invention is also effective for agricultural products such as wasabi and grapes.

### REFERENCE SIGNS LIST

1: Frame body, 2: Planter, 3: Light source

1. A plant cultivation method characterized in that
in a second step which corresponds to a period from cotyledon opening to inflorescence development in a process of plant growth,
a plant is irradiated with irradiation light containing visible light having a photosynthetic photon flux density (PPFD-VL) of 29 (μmol/m²·s) or more and 120 (μmol/m²·s) or less in a visible light region with a wavelength of 400 nm or more and 700 nm or less,
in the visible light, the photosynthetic photon flux density in a blue light region (PPFD-B) with a wavelength of 400 nm or more and less than 500 nm is set to be 5 (μmol/m²·s) or more and 20 (μmol/m²·s) or less,
in the visible light, the photosynthetic photon flux density in a green light region (PPFD-G) with a wavelength of 500 nm or more and less than 600 nm is set to be 10 (μmol/m²·s) or more and 50 (μmol/m²·s) or less,
in the visible light, the photosynthetic photon flux density in a red light region (PPFD-R) with a wavelength of 600 nm or more and less than 700 nm is set to be 14 (μmol/m²·s) or more and 50 (μmol/m²·s) or less, and
a color temperature of the irradiation light is set to be 3000 K or higher and 4800 K or lower.

2. The plant cultivation method according to claim 1, characterized in that
in a first step which corresponds to a period from sowing to germination of seeds in a process of plant growth conducted prior to the second step,
the plant is irradiated with the irradiation light containing the visible light having the photosynthetic photon flux density (PPFD-VL) of 59 (μmol/m²·s) or more and 135 (μmol/m²·s) or less in the visible light region with the wavelength of 400 nm or more and 700 nm or less,
in the visible light, the photosynthetic photon flux density in the blue light region (PPFD-B) with the wavelength of 400 nm or more and less than 500 nm is set to be 11 (μmol/m²·s) or more and 25 (μmol/m²·s) or less,
in the visible light, the photosynthetic photon flux density in the green light region (PPFD-G) with the wavelength of 500 nm or more and less than 600 nm is set to 20 (μmol/m²·s) or more and 50 (μmol/m²·s) or less, and
in the visible light, the photosynthetic photon flux density in the red light region (PPFD-R) with the wavelength of 600 nm or more and less than 700 nm is set to be 28 (μmol/m²·s) or more and 60 (μmol/m²·s) or less.

3. The plant cultivation method according to claim 1, characterized in that
the plant belongs to the family Rosaceae, and
in the second step,
the plant is irradiated with the irradiation light containing the visible light having the photosynthetic photon flux density (PPFD-VL) of 90 (μmol/m²·s) or more and 120 (μmol/m²·s) or less in the visible light region with the wavelength of 400 nm or more and 700 nm or less,
in the visible light, the photosynthetic photon flux density in the blue light region (PPFD-B) with the wavelength of 400 nm or more and less than 500 nm is set to be 10 (μmol/m²·s) or more and 20 (μmol/m²·s) or less,
in the visible light, the photosynthetic photon flux density in the green light region (PPFD-G) with the wavelength of 500 nm or more and less than 600 nm is set to be 30 (μmol/m²·s) or more and 50 (μmol/m²·s) or less,
in the visible light, the photosynthetic photon flux density in the red light region (PPFD-R) with the wavelength of 600 nm or more and less than 700 nm is set to be 30 (μmol/m²·s) or more and 50 (μmol/m²·s) or less, and
the color temperature of the irradiation light in the second step is set to be 4000 K or higher and 4500 K or lower.

4. The plant cultivation method according to claim 3, characterized in that the plant is strawberry.

5. The plant cultivation method according to claim 2, characterized in that the plant is irradiated with the irradiation light in a temperature environment of 9° C. or higher and 28° C. or lower in the first and second steps.

6. The plant cultivation method according to claim 2, characterized in that
a first peak value which is a peak value at a maximum wavelength of the irradiation light is 400 nm or more and 500 nm or less in the first step and the second step, and
a second peak value which is a peak value at the next highest wavelengths of the irradiation light after the first peak value is 550 nm or more and 700 nm or less.
